(19) United States
(12) Patent Application Publication
(10) Pub. No.: US 2019/0031098 A1
(43) Pub. Date: Jan. 31, 2019

(54) INFORMATION OUTPUT DEVICE AND INFORMATION OUTPUT METHOD

(71) Applicant: DENSO TEN Limited, Kobe-shi (JP)

(72) Inventors: Tamaki TAKEUCHI, Kobe-shi (JP); Takahiro NAKAGAWA, Kobe-shi (JP)

(73) Assignee: DENSO TEN Limited, Kobe-shi (JP)

(21) Appl. No.: 15/925,924

(22) Filed: Mar. 20, 2018

(30) Foreign Application Priority Data
Jul. 26, 2017 (JP) 2017-144928

(51) Int. Cl. B60Q 9/00; G06F 3/16; G06F 3/0488

(52) U.S. Cl. CPC B60Q 9/00; G06F 3/0482; G06F 3/0488; G06F 3/165

(57) ABSTRACT

An information output device according to an embodiment includes a detection unit, a display control unit, and a sound control unit. The detection unit detects an operation of a user that is executed on an input unit that is connected to a display unit. The display control unit displays, on the display unit, a notification screen that presents predetermined notification information to the user. The sound control unit outputs a notification sound that is associated with display of the notification screen that is executed by the display control unit. Furthermore, the sound control unit limits output of the notification sound for a period of time when an operation of the user is detected by the detection unit.

### CROSS-REFERENCE TO RELATED APPLICATION

This application is based upon and claims the benefit of priority of the prior Japanese Patent Application No. 2017-144928, filed on Jul. 26, 2017, the entire contents of which are incorporated herein by reference.

### FIELD

The embodiment discussed herein is directed to an information output device and an information output method.

### BACKGROUND

An information output device has conventionally been known that outputs a notification sound (a so-called pop-up sound) dependent on a display content, for example, in a case where a notification screen such as pop-up display is displayed on, for example, an on-vehicle navigation device. An information output device executes display of a notification screen and output of a notification sound, for example, every time a predetermined event such as an approach to a destination occurs for a vehicle (see, for example, Japanese Laid-open Patent Publication No. 2010-067129).

However, in a conventional technique, in a case where a lot of events occur in, for example, a movable body such as a vehicle, a user may feel a complication in a case where display of a notification screen and output of a notification sound are executed for all of such events.

### SUMMARY

An information output device according to an embodiment includes a detection unit, a display control unit, and a sound control unit. The detection unit detects an operation of a user that is executed on an input unit that is connected to a display unit. The display control unit displays, on the display unit, a notification screen that presents predetermined notification information to the user. The sound control unit outputs a notification sound that is associated with display of the notification screen that is executed by the display control unit. Furthermore, the sound control unit limits output of the notification sound for a period of time when an operation of the user is detected by the detection unit.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram illustrating an outline of an information output method according to an embodiment.

FIG. 2 is a block diagram illustrating a configuration of an information output device according to an embodiment.

FIG. 3 is a diagram illustrating a processing content of a sound control unit.

FIG. 4 is a diagram illustrating a processing content of a sound control unit.

FIG. 5 is a diagram illustrating a processing content of a sound control unit.

FIG. 6 is a diagram illustrating a positional relationship between an input unit and a display unit.

FIG. 7 is a flowchart illustrating processing steps of an output control process that is executed by an information output device according to an embodiment.

### DESCRIPTION OF EMBODIMENT

Hereinafter, an embodiment of an information output device and an information output method as disclosed in the present application will be described in detail with reference to the accompanying drawings. Additionally, the present invention is not limited by such an embodiment(s).

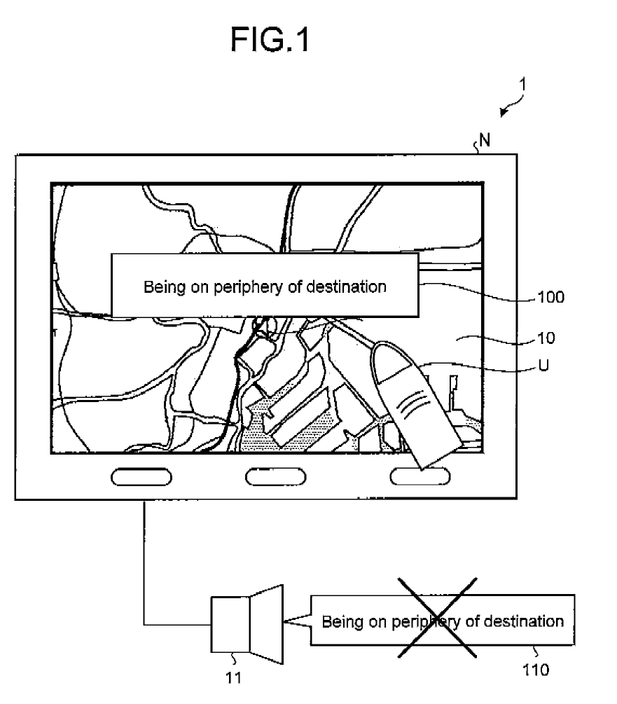

First, an outline of an information output method according to an embodiment will be described by using FIG. 1. FIG. 1 is a diagram illustrating an outline of an information output method according to an embodiment. FIG. 1 illustrates a case where an information output method is applied to an on-vehicle navigation device N. Additionally, an object for applying an information output method thereto is not limited to the on-vehicle navigation device N and it is sufficient for a device to execute control for screen display that is associated with a sound.

Furthermore, the navigation device N in FIG. 1 includes a touch panel display 10 that serves as both a display unit and an input unit and a speaker 11. Furthermore, in FIG. 1, a user executes a touch operation with his or her finger U (an example of an operation of a user) on a screen where a map is displayed thereon, and a notification screen 100 that indicates that he or she is on a periphery of a destination is displayed thereon.

The notification screen 100 is a screen that presents, to a user, notification information that indicates, for example, occurrence of a predetermined event every time such an event occurs. For example, as illustrated in FIG. 1, the notification screen 100 such as “Being on periphery of destination” is pop-up-displayed in a case where his or her own vehicle approaches a set destination. Additionally, the notification screen 100 is not limited to pop-up display and it is sufficient to change all or a part of a screen.

In an information output method according to an embodiment, output of a notification sound 110 that is associated with the notification screen 100 is limited, as long as an operation of a user (a touch operation) is executed. For example, the notification sound 110 as described herein is information on a sound such as a sound that is provided in accordance with a content of the notification screen 100, such as “Being on periphery of destination” as illustrated in FIG. 1. Additionally, the notification sound 110 is not limited to a sound and may be, for example, a single sound such as “pong”. Furthermore, the notification sound 110 may include a buzzer sound or a melodic sound.

A conventional information output method will be described herein. Conventionally, a notification sound that is associated with a notification screen is output every time the notification screen is displayed. However, a lot of events that display a notification screen occur in, for example, a movable body such as a vehicle, and hence, if such a notification sound is output for all of notification screens, a user may feel a complication.

Accordingly, in an information output method according to an embodiment, output of the notification sound 110 is limited. Specifically, in an information output method according to an embodiment, the notification sound 110 is limited for a period of time when an operation of a user that is executed on an input unit that is connected to a display unit (touch panel display 10) is detected.

In an information output method according to an embodiment, for example, in a case where the notification screen 100 is displayed within a period of time when a user executes a touch operation on a screen by his or her finger U, output of the notification sound 110 is stopped, that is, the notification sound 110 is not output, as illustrated in FIG. 1.

That is, there is a high possibility that a user looks at a screen during an operation thereof, and hence, it is possible to recognize the notification screen 100 naturally without purposely outputting the notification sound 110. In other words, the notification sound 110 is limitatively output for only a period of time when a user does not execute an operation. Therefore, it is possible for an information output method according to an embodiment to reduce a complication for a user.

Additionally, an information output device 1 according to an embodiment does not have to stop output of the notification sound 110 and may, for example, reduce a volume of an output sound, delay output of the notification sound 110, or limit it to a minimum to be notified of, such as receipt of a phone call.

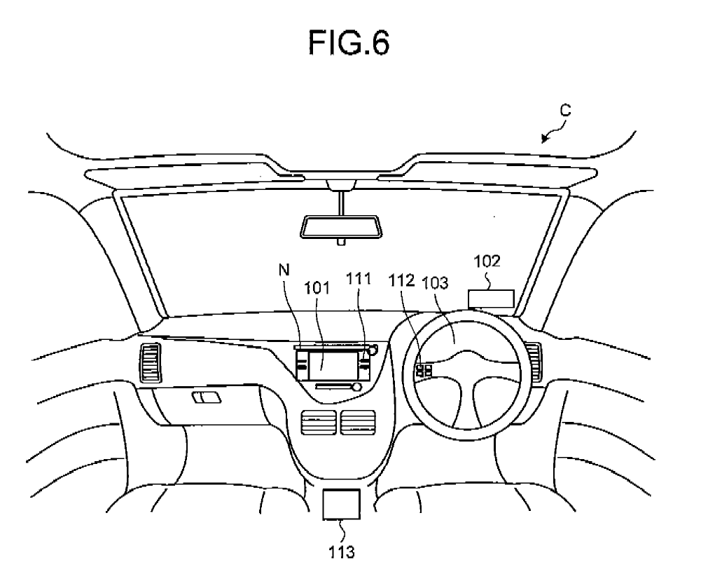

Furthermore, a display unit and an input unit are not limited to the touch panel display 10. Another example of a display unit and an input unit will be described later by using FIG. 6.

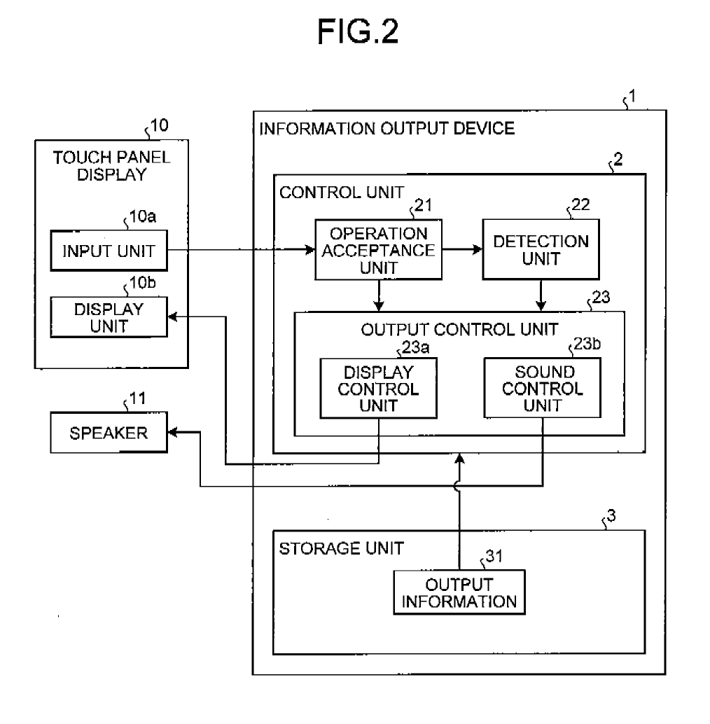

Next, a configuration of an information output device 1 according to an embodiment will be described in detail with reference to FIG. 2. FIG. 2 is a block diagram illustrating a configuration of an information output device 1 according to an embodiment. Additionally, in FIG. 2, only components that are needed to explain a feature(s) of the present embodiment are represented by functional blocks and illustration of general components is omitted.

In other words, each component as illustrated in FIG. 2 is functionally conceptual and does not have to be physically configured as illustrated in the figure. For example, a specific embodiment of dispersion or integration of respective functional blocks is not limited to that illustrated in the figure and it is possible to disperse or integrate all or a part thereof functionally or physically in an arbitrary unit for its configuration, depending on a variety of loads, a usage, or the like.

As illustrated in FIG. 2, the information output device 1 according to an embodiment is connected to a touch panel display 10 and a speaker 11. The touch panel display 10 includes an input unit 10a and a display unit 10b.

The information output device 1 according to an embodiment includes a control unit 2 and a storage unit 3. The control unit 2 includes an operation acceptance unit 21, a detection unit 22, and an output control unit 23. The storage unit 3 stores output information 31.

Herein, the information output device 1 includes, for example, a computer that has a Central Processing Unit (CPU), a Read Only Memory (ROM), a Random Access Memory (RAM), a Hard Disk Drive (HDD), an input/output port, and the like, and a variety of circuits.

A CPU of a computer reads and executes, for example, a program stored in a ROM and thereby functions as the operation acceptance unit 21, the detection unit 22, and the output control unit 23 of the control unit 2.

Furthermore, it is also possible to configure at least one or all of the operation acceptance unit 21, the detection unit 22, and the output control unit 23 of the control unit 2 by hardware such as an Application Specific Integrated Circuit (ASIC) or a Field Programmable Gate Array (FPGA).

Furthermore, the storage unit 3 corresponds to, for example, a RAM or a HDD. It is possible for a RAM or a HDD to store the output information 31, information of a variety of programs, and the like. Additionally, the information output device 1 may acquire a program as described above or a variety of information through another computer that is connected by a wired or wireless network or a portable recording medium.

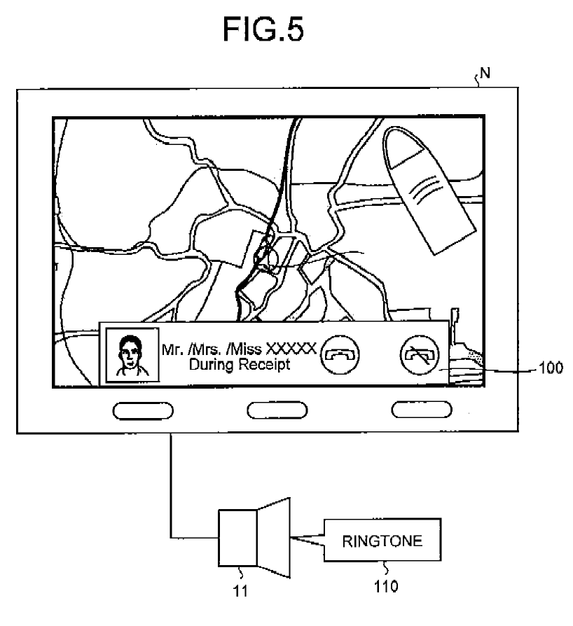

The output information 31 is information that includes information on a notification screen 100 and a notification sound 110 or information on a priority of notification information. Additionally, a priority of notification information will be described later, along with FIG. 5.

The control unit 2 detects whether or not a user executes an operation on the input unit 10a, and executes control as to whether or not the notification sound 110 is output in accordance with display of the notification screen 100 that presents predetermined notification information to a user, based on a result of such detection.

The operation acceptance unit 21 accepts an operation of a user on the input unit 10a and outputs operation information on such an operation to the detection unit 22 and the output control unit 23. For example, the operation acceptance unit 21 outputs, as operation information, information of a touch position on the touch panel display 10.

The detection unit 22 detects, and outputs to the output control unit 23, an operation of a user that is executed on the input unit 10a, based on operation information of the operation acceptance unit 21. For example, the detection unit 22 also measures, and outputs to the output control unit 23, an elapsed time after a touch operation is executed. Furthermore, the detection unit 22 detects an operation of a user on a second screen that is different from a first screen, where such a matter will be described later.

The output control unit 23 includes a display control unit 23a and a sound control unit 23b, and executes display control of the notification screen 100 and output control of the notification sound 110.

The display control unit 23a displays, on the display unit 10b, the notification screen 100 that presents predetermined notification information to a user. For the notification screen 100, there is provided, for example, notification of receipt of a phone call, notification of a route to a destination that is set by a non-illustrated navigation device (for example, notification that indicates a periphery of a destination, enlarged display when approaching a fork such as an intersection, or the like), notification of Point Of Interest (POI) information, notification of data acquisition from an external device, or the like.

The sound control unit 23b executes output control of the notification sound 110 that is associated with display of the notification screen 100 that is executed by the display control unit 23a. For example, the sound control unit 23b limits output of the notification sound 110 for a period of time when an operation of a user is detected by the detection unit 22.

Specifically, the sound control unit 23b limits output of the notification sound 110 in a case where the notification screen 100 that indicates a result that is based on an operation of a user is displayed by the display control unit 23a. For example, a user executes a series of operations for setting a destination, so that such a destination is set.

In such a case, the display control unit 23a first displays the notification screen 100 for completion of setting that is a result of an operation such as, for example, “XXXXX is set as destination”. Herein, the sound control unit 23b does not output the notification sound 110 in accordance with the notification screen 100 of “XXXXX is set as destination”.

This is because the notification screen 100 for completion of setting, such as “XXXXX is set as destination” is displayed immediately after a user executes an operation, and hence, is considered to be naturally viewed by a user. Therefore, output of the notification sound 110 is limited for the notification screen 100 that is displayed as a result of an operation of a user, so that it is possible to reduce a complication for a user.

Additionally, a period of time when an operation of a user is detected by the detection unit 22 does not have to be limited to a case where an operation of a user is detected continuously, and may be, for example, a case where an operation of a user is detected intermittently. For example, in a case where a period of time after a previous operation of a user is detected and before a next operation of the user is detected is a predetermined period of time (for example, 1 second) or less, an operation of the user may be regarded as being continuous.

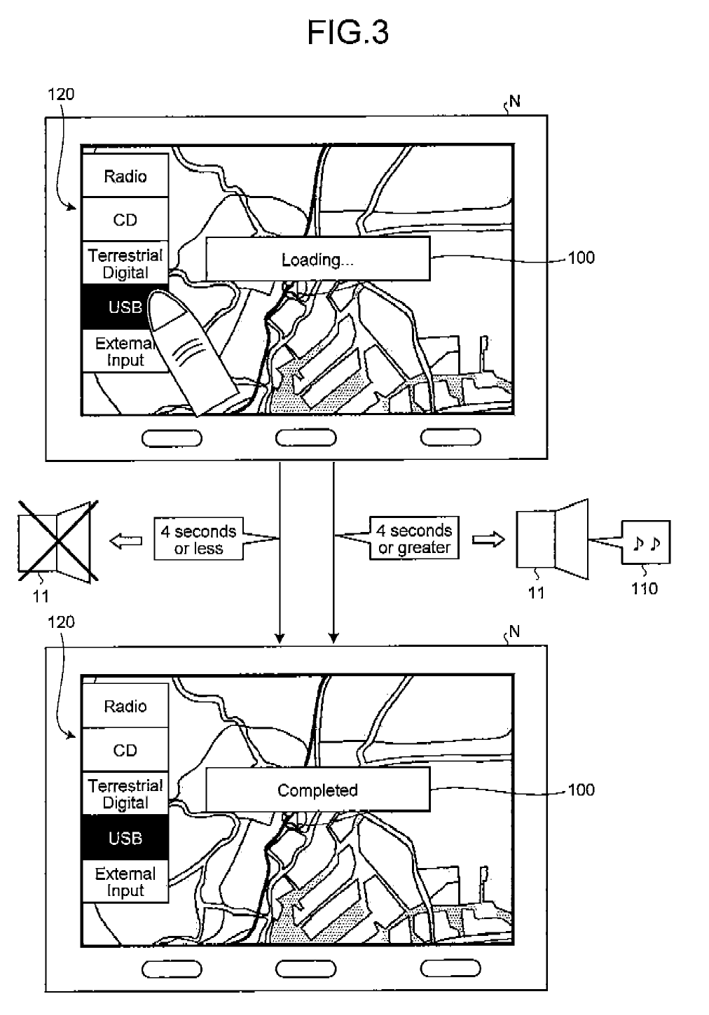

Furthermore, the sound control unit 23b may output the notification sound 110 in a case where it takes some time to display the notification screen 100 that indicates a result of an operation of a user. Such a matter will be described by using FIG. 3.

FIG. 3 is a diagram illustrating a processing content of the sound control unit 23b. FIG. 3 illustrates a situation where a user operates a menu screen 120 that is displayed on a part of a screen so that predetermined information (for example, a phone book or music data) is caused to transfer, for example, an external recording medium such as a Universal Serial Bus (USB) flash drive to a navigation device N. Additionally, the menu screen 120 is a screen that is caused to appear by a predetermined operation of a user.

Usually, in a case where information is caused to transfer from an external recording medium or the like and an amount of data is large, it takes some time to complete data transfer, so that the display control unit 23a displays, as a notification screen 100, a busy message such as “Loading . . . ” as illustrated in FIG. 3 as long as a process of data transfer is executed. Additionally, the notification screen 100 such as “Loading . . . ” is displayed immediately after an operation of a user, and hence, a notification sound 110 is not output by the sound control unit 23b.

Then, the sound control unit 23b determines whether the notification sound 110 is allowed to be output depending on a waiting time after an operation of a user and before the notification screen 100 that indicates a result of such an operation is displayed. Specifically, in a case where data transfer is completed, the display control unit 23a first displays the notification screen 100 that indicates completion of a process, such as “Completed” as illustrated in a lower part of FIG. 3.

Then, as illustrated in FIG. 3, the sound control unit 23b limits output of (for example, does not output) the notification sound 110 in a case where a waiting time after “Loading . . . ” is displayed and before “Completed” is displayed is less than a predetermined period of time (for example, 4 seconds). That is, for the notification screen 100 that indicates a result of an operation of a user, the sound control unit 23b continues limitation of the notification sound 110 for a predetermined period of time after the operation of the user (for example, 4 seconds).

On the other hand, the sound control unit 23b removes limitation of the notification sound 110, that is, outputs the notification sound 110, in a case where a waiting time after “Loading . . . ” is displayed and before “Completed” is displayed is a predetermined period of time or greater.

That is, the sound control unit 23b determines that a user still looks at a screen and limits the notification sound 110, for example, in a case where a waiting time is less than 4 seconds, or determines that a user takes his or her eyes away from a screen and outputs the notification sound 110 in a case where a waiting time is 4 seconds or greater. Thereby, it is possible to reduce a complication for a user and it is possible to recognize the notification screen 100 such as completion of a process reliably even in a case where a user takes his or her eyes away from a screen.

Furthermore, the sound control unit 23b stops output of the notification sound 110, so that it is possible to prevent a user from getting used to the notification sound 110, and hence, it is possible to cause a user to recognize the notification sound 110 effectively.

Additionally, although output control of the notification screen 100 and the notification sound 110 in a case of data transfer is explained in FIG. 3, data transfer is not limiting and it is sufficient for a process to take a predetermined time or longer after an operation of a user and before the notification screen 100 is displayed.

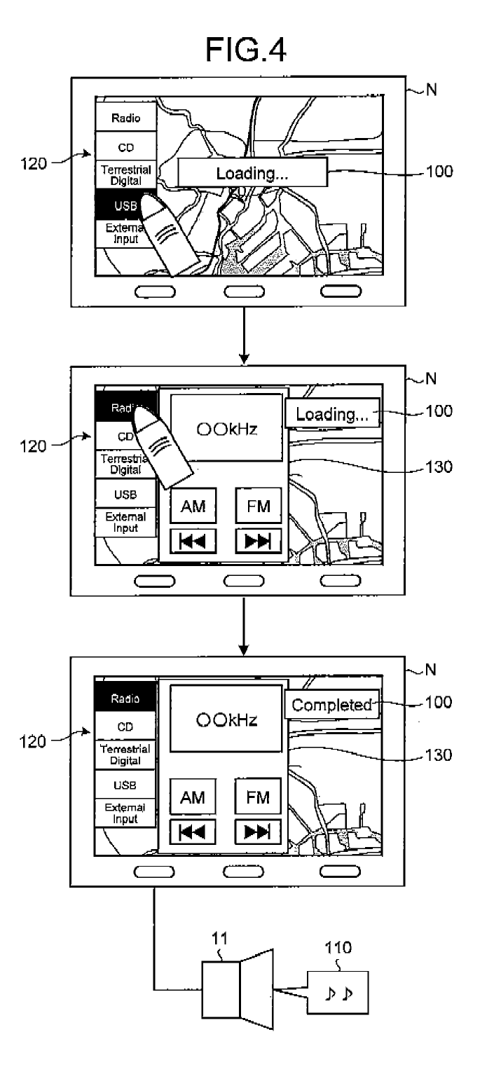

Additionally, although a case where a screen for data transfer still continues to be displayed during a waiting time is explained in FIG. 3, the notification sound 110 may be output, for example, in a case where a user switches to another screen during a waiting time for data transfer or the like, even in a case where a waiting time is less than a predetermined period of time (for example, 4 seconds). Such a matter will be described by using FIG. 4.

FIG. 4 is a diagram illustrating a processing content of the sound control unit 23b. FIG. 4 illustrates a situation where a user operates a menu screen 120 within a waiting time when data transfer is executed, so as to switch to a screen for a radio. In such a case, even in a case where switching to a screen for a radio is executed, a process for data transfer is continued to be executed.

In such a case, the sound control unit 23b removes limitation of a notification sound 110 for a notification screen 100 that indicates a result of an operation of a user in a case where switching from a first screen to a second screen is executed within a waiting time before the notification screen 100 is displayed on the first screen. That is, the sound control unit 23b outputs the notification sound 110 that indicates a result on a previous screen (a first screen) even in a case where a user is executing an operation on a second screen.

For example, in FIG. 4, a first screen is a screen in a state where “USB” in the menu screen 120 is selected and a second screen refers to a screen in a state where “Radio” in the menu screen 120 is selected.

That is, the sound control unit 23b outputs the notification sound 110 in a case where a user switches to a screen 130 for “Radio” while the notification screen 100 of “Loading . . . ” that indicates data transfer is displayed, even in a case where a waiting time is less than a predetermined period of time (for example, 4 seconds).

Herein, the display control unit 23a displays, on a second screen, “Loading . . . ” that is the notification screen 100 on a first screen, and displays the notification screen 100 of “Completed” in a case where a process is completed. Additionally, in a case where the notification screen 100 is displayed on a second screen, a display size for a first screen is reduced to some extent to execute display thereof.

Thereby, it is possible to prevent a second screen from being hidden. Additionally, only the notification sound 110 may be output without displaying the notification screen 100 (both “Loading . . . ” and “Completed”) on a second screen.

Thus, after switching from a first screen to a second screen is executed, the notification sound 110 is output for a result of a process on the first screen, so that it is possible for a user to recognize a process on the first screen again, even in a case of forgetting thereof.

Additionally, the notification sound 110 with limitation that is removed by the sound control unit 23b is just only the notification sound 110 that is caused by a result of an operation of a user on a previous screen (a first screen). In other words, a user also continues an operation after switching to a second screen is executed, and a limitation that is executed by the sound control unit 23b is applied to the notification sound 110 for a second screen that is irrelevant to the notification sound 110 for a first screen.

Furthermore, FIG. 4 merely illustrates a combination of “USB” and “Radio” as an example of a combination of a first screen and a second screen, and any combination of menu screens 120 may be provided. Alternatively, a combination of a menu screen 120 and another screen such as a non-illustrated destination setting screen may be provided.

Furthermore, although the sound control unit 23b limits output of the notification sound 110 as long as a user executes an operation, limitation of the notification sound 110 may be removed for an important matter for such a user. Such a matter will be described by using FIG. 5.

FIG. 5 is a diagram illustrating a processing content of the sound control unit 23b. FIG. 5 illustrates a situation where receipt of a phone call is executed while a user operates a screen. The sound control unit 23b determines whether or not limitation of a notification sound 110 is allowed based on a priority of notification information that is presented by a notification screen 100.

As illustrated in FIG. 5, in a case where receipt of a phone call is executed, the display control unit 23a first displays the notification screen 100 that indicates such a receipt. Then, the sound control unit 23b outputs a ringtone that is the notification sound 110 regardless of whether or not an operation of a user is detected.

That is, the sound control unit 23b treats receipt of a phone call as notification information that has to be recognized by a user, that is, provides it as notification information with a priority that is a predetermined value or greater, and outputs the notification sound 110. Additionally, for example, a priority may preliminarily be set by a user or may arbitrarily be set depending on a type of notification information.

Thus, the notification sound 110 is output for notification information with a high priority regardless of an operation of a user, so that it is possible to recognize important information for a user reliably.

Additionally, although the sound control unit 23b in FIG. 5 outputs the notification sound 110 regardless of presence or absence of an operation of a user in a case where a priority is a predetermined value or greater, a degree of limitation of the notification sound 110 may be changed depending on, for example, a value of a priority.

Specifically, in a case where the notification screen 100 is displayed that indicates notification information with a priority that is a predetermined value or greater (for example, receipt of a phone call) for a period of time when an operation of a user is detected by the detection unit 22, the sound control unit 23b does not immediately output the notification sound 110 but outputs the notification sound 110 after a predetermined period of time.

That is, there is a high possibility that a user notices receipt of a phone call during an operation thereof, so that the notification sound 110 is not output, whereas the notification sound 110 is output in a case where a user does not execute any operation for a response to such a receipt for a certain period of time. Thereby, it is possible to recognize important information for a user reliably and it is possible to reduce a complication for such a user.

Next, a process of the sound control unit 23b in a positional relationship between the input unit 10a and the display unit 10b in a vehicle C will be described by using FIG. 6. FIG. 6 is a diagram illustrating a positional relationship between the input unit 10a and the display unit 10b.

Additionally, FIG. 6 illustrates a case where the input unit 10a and the display unit 10b are separate bodies. In an example as illustrated in FIG. 6, the input unit 10a will be described by providing a physical button 111, a steering switch 112, and a touch pad 113 of a navigation device N as examples.

Furthermore, the display unit 10b will be described by providing a center display 101, a head-up display 102, and a meter display 103 of the navigation device N as examples.

Additionally, each display unit 10b is connected to a plurality of input units 10a. For example, the center display 101 is connected to each of the physical button 111, the steering switch 112, and the touch pad 113.

In such a case, the sound control unit 23b determines presence or absence of limitation of the notification sound 110 based on a positional relationship between the display unit 10b and the input unit 10a. Specifically, the sound control unit 23b removes limitation of the notification sound 110 in a case where an operation of a user on the input unit 10a that is arranged away from the display unit 10b by a predetermined distance or greater, among the plurality of input units 10a, is detected.

For example, the sound control unit 23b outputs the notification sound 110, that is, removes limitation of the notification sound 110, in a case where an operation of a user is executed on the center display 101 through the steering switch 112 or the touch pad 113. On the other hand, the sound control unit 23b removes limitation of the notification sound 110, in a case where an operation of a user is executed on the center display 101 through the physical button 111.

That is, in a case where an operation is executed through the input unit 10a at a position distant from the display unit 10b to some extent, there is a comparatively low possibility that a user looks at a screen, and hence, the notification sound 110 is output, so that it is possible for a user to recognize the notification screen 100 reliably.

Furthermore, the sound control unit 23b may limit output of the notification sound 110, for example, in a case where an operation of a user is executed on the head-up display 102 or the meter display 103 through the steering switch 112.

That is, there is a high possibility that a driver that is a user brings the head-up display 102 or the meter display 103 into view naturally in order to execute driving, and hence, it is possible to recognize the notification screen 100 even in a case where the sound control unit 23b does not output the notification sound 110. That is, it is possible to reduce a complication for a user. Thus, output control of the notification sound 110 is executed based on a positional relationship between the display unit 10b and the input unit 10a, so that it is possible to reduce a complication for a user.

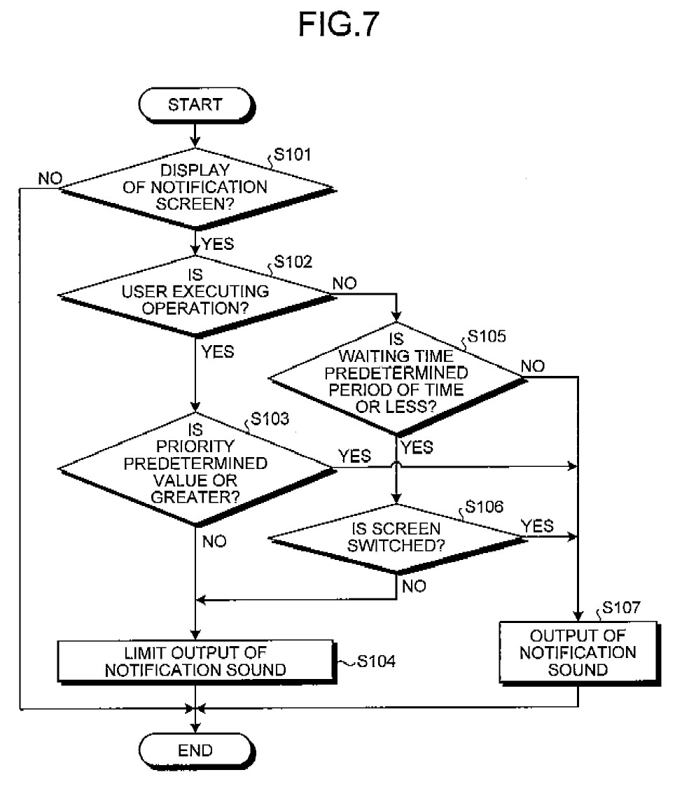

Next, processing steps of an output control process that is executed by the information output device 1 according to an embodiment will be described by using FIG. 7. FIG. 7 is a flowchart illustrating processing steps of an output control process that is executed by the information output device 1 according to an embodiment.

As illustrated in FIG. 7, first, the display control unit 23a determines whether or not the notification screen 100 that presents predetermined notification information to a user is displayed on the display unit 10b (step S101).

Then, in a case where the display control unit 23a determines that the notification screen 100 is displayed on the display unit 10b (step S101, Yes), the detection unit 22 determines whether or not an operation of a user that is executed on the input unit 10a that is connected to the display unit 10b is detected (that is, whether or not an operation is being executed) (step S102).

Then, in a case where an operation of a user is detected by the detection unit 22 (step S102, Yes), the sound control unit 23b determines whether or not a priority of notification information in the notification screen 100 is a predetermined value or greater (step S103).

Then, in a case where a priority of notification information is less than a predetermined value (step S103, No), the sound control unit 23b limits output of the notification sound 110 for a period of time when a user executes an operation (step S104), and ends such a process.

On the other hand, in a case where the display control unit 23a determines that the notification screen 100 is not displayed on the display unit 10b at step S101 (step S101, No), such a process is ended.

Furthermore, in a case where an operation of a user is not detected by the detection unit 22, that is, an operation is not being executed, at step S102 (step S102, No), the sound control unit 23b determines whether or not a waiting time before the notification screen 100 is displayed is less than a predetermined period of time (step S105).

In a case where a waiting time before the notification screen 100 is displayed is less than a predetermined period of time (step S105, Yes), the sound control unit 23b determines whether or not switching from a first screen to a second screen is executed by an operation of a user (step S106).

In a case where switching from a first screen to a second screen is not executed by an operation of a user (step S106, No), the sound control unit 23b transfers such a process to step S104.

On the other hand, in a case where a waiting time before the notification screen 100 is displayed is a predetermined period of time or greater at step S105 (step S105, No), the sound control unit 23b removes limitation of the notification sound 110, that is, outputs the notification sound 110 (step S107), and ends such a process.

Furthermore, in a case where a priority of notification information is a predetermined value or greater at step S103 (step S103, Yes), the sound control unit 23b transfers such a process to step S107.

Furthermore, in a case where switching from a first screen to a second screen is executed by an operation of a user at step S106 (step S106, Yes), the sound control unit 23b transfers such a process to step S107.

As described above, the information output device 1 according to an embodiment includes the detection unit 22, the display control unit 23a, and the sound control unit 23b. The detection unit 22 detects an operation of a user that is executed on the input unit 10a that is connected to the display unit 10b. The display control unit 23a displays, on the display unit 10b, the notification screen 100 that presents predetermined notification information to a user. The sound control unit 23b outputs the notification sound 110 that is associated with display of the notification screen 100 that is executed by the display control unit 23a. Furthermore, the sound control unit 23b limits output of the notification sound 110 for a period of time when an operation of a user is detected by the detection unit 22. Thereby, it is possible to reduce a complication for a user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information output device, comprising:
a detection unit that detects an operation of a user that is executed on an input unit that is connected to a display unit;
a display control unit that displays, on the display unit, a notification screen that presents predetermined notification information to the user; and
a sound control unit that outputs a notification sound that is associated with display of the notification screen that is executed by the display control unit, wherein
the sound control unit limits output of the notification sound for a period of time when an operation of the user is detected by the detection unit.

2. The information output device according to claim 1, wherein the sound control unit stops output of the notification sound for a period of time when an operation of the user is detected by the detection unit.

3. The information output device according to claim 1, wherein
the display control unit displays the notification screen that indicates a result that is based on an operation of the user, and
the sound control unit limits output of the notification sound in a case where the notification screen that indicates the result is displayed.

4. The information output device according to claim 2, wherein
the display control unit displays the notification screen that indicates a result that is based on an operation of the user, and
the sound control unit limits output of the notification sound in a case where the notification screen that indicates the result is displayed.

5. The information output device according to claim 3, wherein the sound control unit continues limitation of the notification sound during a predetermined period of time after an operation of the user for the notification screen that indicates the result.

6. The information output device according to claim 4, wherein the sound control unit continues limitation of the notification sound during a predetermined period of time after an operation of the user for the notification screen that indicates the result.

7. The information output device according to claim 3, wherein
the detection unit further detects an operation of the user on a second screen that is different from a first screen where the notification screen is displayed thereon, and
the sound control unit removes limitation of the notification sound for the notification screen in a case where switching from the first screen to the second screen is executed during a waiting time before the notification screen that indicates the result is displayed on the first screen.

8. The information output device according to claim 4, wherein
the detection unit further detects an operation of the user on a second screen that is different from a first screen where the notification screen is displayed thereon, and
the sound control unit removes limitation of the notification sound for the notification screen in a case where switching from the first screen to the second screen is executed during a waiting time before the notification screen that indicates the result is displayed on the first screen.

9. The information output device according to claim 1, wherein the sound control unit determines presence or absence of limitation of the notification sound based on a positional relationship between the display unit and the input unit.

10. The information output device according to claim 2, wherein the sound control unit determines presence or absence of limitation of the notification sound based on a positional relationship between the display unit and the input unit.

11. The information output device according to claim 9, wherein
the display unit is connected to a plurality of the input units, and
the sound control unit removes limitation of the notification sound in a case where an operation of the user on the input unit that is arranged away from the display unit by a predetermined distance or greater, among the plurality of the input units, is detected.

12. The information output device according to claim 10, wherein
the display unit is connected to a plurality of the input units, and
the sound control unit removes limitation of the notification sound in's case where an operation of the user on the input unit that is arranged away from the display unit by a predetermined distance or greater, among the plurality of the input units, is detected.

13. An information output method, comprising:
a detection step that detects an operation of a user that is executed on an input unit that is connected to a display unit;
a display control step that displays, on the display unit, a notification screen that presents predetermined notification information to the user; and
a sound control step that outputs a notification sound that is associated with display of the notification screen that is executed in the display control step, wherein
the sound control step limits output of the notification sound for a period of time when an operation of the user is detected in the detection step.
